(19) United States
(12) Patent Application Publication
(10) Pub. No.: US 2015/0379492 A1
(43) Pub. Date: Dec. 31, 2015

(54) Systems, Apparatuses, Methods and Computer Executable Code for Facilitating Monetary Transactions Relating to Online Media Content

(71) Applicant: LIVE LENS LTD., Tel Aviv (IL)

(72) Inventors: Max Eitan Bluvband, Gibton (IL); Shahar Hajdu, Givataim (IL); Zigmund Bluvband, Rishon LeZion (IL)

(21) Appl. No.: 14/753,021

(22) Filed: Jun. 29, 2015

Related U.S. Application Data
(60) Provisional application No. 62/018,617, filed on Jun. 29, 2014.

(51) Int. Cl. G06Q 20/12

(52) U.S. Cl. CPC G06Q 20/123; G06Q 20/127

(57) ABSTRACT

The present invention includes systems, apparatuses, methods and computer executable code for facilitating monetary transactions relating to online media content. According to some embodiments of the present invention, there may be provided systems, apparatuses or methods for facilitating monetary transactions relating to online media content including a Media Content Presentation and Payment (MCPP) client application and/or a MCPP server adapted to present media content and/or facilitate monetary transactions relating to online media content via existing payment arrangements relating to payment for mobile device applications and associated products (e.g. IOS App Store™, Windows Phone Marketplace™, Google Play™, etc).

### PRIORITY CLAIMS

This application claims priority from U.S. Provisional Patent Application No. 62/018,617, filed on Jun. 29, 2014 by the inventors of the present invention, titled “Systems, Apparatuses, Methods and Computer Executable Code for Facilitating Monetary Transactions Relating to Online Media Content”, which is hereby incorporated by reference in its entirety.

### FIELD OF THE INVENTION

The present invention generally relates to online entertainment. More specifically, the present invention relates to systems, apparatuses, methods and computer executable code for facilitating monetary transactions relating to online media content.

### BACKGROUND

Over the past couple decades, there has been a major shift in the channels used by people to receive media content. The stellar rise in speed and quality of internet access to the common person has brought about a new era in the media world. In the very recent past, media content was consumed primarily through television, theaters and the purchase/rent of the content (e.g. cd's, dvd's, pay per view, etc.). Nowadays, however, most media consumption is accomplished online; often times from mobile devices. It has become a common site to see individuals viewing video clips or even movies on their portable devices. This shift has created difficulties for the producers of the content to receive payment for their product.

Accordingly, the media business has been attempting, over recent years, to find new ways to commercialize the consumption of media content online. Many methods for adding advertising to media content online have been developed (e.g. YouTube). In parallel, many subscription type platforms for media content access have risen (e.g. NetFlix). There remains, however, a need for new and innovative manners to commercialize media content presentation online.

### SUMMARY OF THE INVENTION

The present invention includes systems, apparatuses, methods and computer executable code for facilitating monetary transactions relating to online media content (hereinafter referred to as “Media Content Presentation and/or Payment systems” or “MCPP systems”). According to some embodiments of the present invention, there may be provided systems, apparatuses and/or methods for facilitating monetary transactions relating to online media content including one or more Media Content Presentation and/or Payment (MCPP) client applications and/or one or more MCPP servers adapted to present media content and/or facilitate monetary transactions relating to online media content via existing payment arrangements relating to payment for mobile device applications and associated products (e.g. IOS App Store™, Windows Phone Marketplace™, Google Play™, etc). Hereinafter, such payment arrangements will collectably be referred to as “Mobile Application Markets” or “MAM's”. According to some embodiments, MCPP client applications and/or MCPP servers may provide a user of a computational device a listing of available media content, along with a listing of prices for each content item in the list. Upon a selection and agreement to pay for a given content item, the MCPP client application and/or MCPP server may provide the user with an option to view/hear the selected content and debit the user the associated price via a MAM, using an appropriate application programming interface (API).

According to further embodiments, MCPP client applications and/or MCPP servers may provide a user of a computational device a listing of free available media content, which content the user may view/hear without cost, live or offline. In such embodiments, the MCPP client applications and/or MCPP servers may provide the user viewing the content with a control element designed to allow the user to make a donation or tip to the author/creator/producer of the content. Such donations or tips may be collected via a MAM, using an appropriate application programming interface (API).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1D: are diagrams of exemplary architectures of MCPP systems, in accordance with some embodiments of the present invention, wherein:

FIG. 1A demonstrates an exemplary MCPP system in which Author Users A, B and C upload media contents to a MCPP server, Viewer Users view media content from the MCPP server and the MCPP server charges the Viewer Users for the Content through a MAM service, all in accordance with some embodiments of the present invention;

FIG. 1B demonstrates an exemplary MCPP system in which Author Users A, B and C upload media contents to a MCPP server, Viewer Users view media content from the MCPP server and the Viewer User's MCPP client applications charge the Viewer Users for the content through a MAM service, all in accordance with some embodiments of the present invention;

FIG. 1C demonstrates an exemplary MCPP system in which Author Users A, B and C upload media contents to a Cloud storage, Viewer Users view media content from the Cloud storage and the Viewer Users' MCPP client applications charge the Viewer Users for the content through a MAM service, all in accordance with some embodiments of the present invention; and

FIG. 1D demonstrates an exemplary MCPP system in which Author Users A, B and C send the media content directly to Viewer Users, for their viewing, and the Viewer Users' MCPP client applications charge the Viewer Users for the content through a MAM service, all in accordance with some embodiments of the present invention;

FIG. 2: is a block diagram of an exemplary computational device including a MCPP client application, in accordance with some embodiments of the present invention;

FIGS. 3A-3C: are flowcharts presenting exemplary steps of operation of an exemplary MCPP system performing Author functionalities, all in accordance with some embodiments of the present invention, wherein:

FIG. 3A demonstrates exemplary uploading of paid content to an exemplary MCPP system;

FIG. 3B demonstrates exemplary uploading of free content to an exemplary MCPP system; and

FIG. 3C demonstrates exemplary uploading of future content to an exemplary MCPP system; and

FIGS. 4A-4C: are flowcharts presenting exemplary steps of operation of an exemplary MCPP system performing Viewer functionalities, all in accordance with some embodiments of the present invention, wherein:

FIG. 4A demonstrates exemplary selection and viewing of paid content facilitated by an exemplary MCPP system;

FIG. 4B demonstrates exemplary selection and viewing of free content facilitated by an exemplary MCPP system; and

FIG. 4C demonstrates exemplary selection and viewing of future content facilitated by an exemplary MCPP system;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, memory cards (for example SD card), SIM cards, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer, communication device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language or markup language. It will be appreciated that a variety of programming languages or techniques may be used to implement the teachings of the inventions as described herein.

Functions, operations, components and/or features described herein with reference to one or more embodiments, may be combined with, or may be utilized in combination with, one or more other functions, operations, components and/or features described herein with reference to one or more other embodiments, or vice versa.

The present invention includes systems, apparatuses, methods and computer executable code for facilitating monetary transactions relating to online media content. According to some embodiments of the present invention, there may be provided systems, apparatuses and/or methods for facilitating monetary transactions relating to online media content including one or more MCPP client applications and/or one or more MCPP servers adapted to present media content and/or facilitate monetary transactions relating to online media content via existing payment arrangements relating to payment for mobile device applications and associated products (e.g. IOS App Store™, Windows Phone Marketplace™, Google Play™, etc), i.e. MAM's. According to some embodiments, MCPP client applications and/or MCPP servers may provide a user of a computational device a listing of available media content, along with a listing of prices for each content item in the list. Upon a selection and agreement to pay for a given content item, the MCPP client application and/or MCPP server may provide the user with an option to view/hear the selected content and debit the user the associated price via a MAM, using an appropriate application programming interface (API).

According to further embodiments, one or more MCPP client applications and/or one or more MCPP servers may provide a user of a computational device a listing of free available media content, which content the user may view/hear without cost. In such embodiments, the MCPP client applications and/or MCPP servers may provide the user viewing the content with a control element designed to allow the user to make a donation or tip to the author/creator/producer/distributor (all hereinafter referred to as “authors”) of the content. Such donations or tips may be collected via a MAM, using an appropriate application programming interface (API).
From this point forward, for the sake of convenience and clarity, the present description will describe the operations and functionalities of the invention as being performed by a MCPP client application. It should be understood, however, that some or all of the functionalities and/or operations described herein as being performed by a MCPP client application may equally be performed by an associated MCPP server. Accordingly, all descriptions herein relating to a MCPP client application should be understood to refer to a MCPP server as well. It should also be understood that any combination of functionalities and operations being performed by a MCPP client device or MCPP server is possible and the particular division of functionalities and operations between the two will depend on practical considerations of the particular implementation of this invention. All such possible division of operations and functionalities between a MCPP client application and MCPP server should be considered within the scope of the present application.

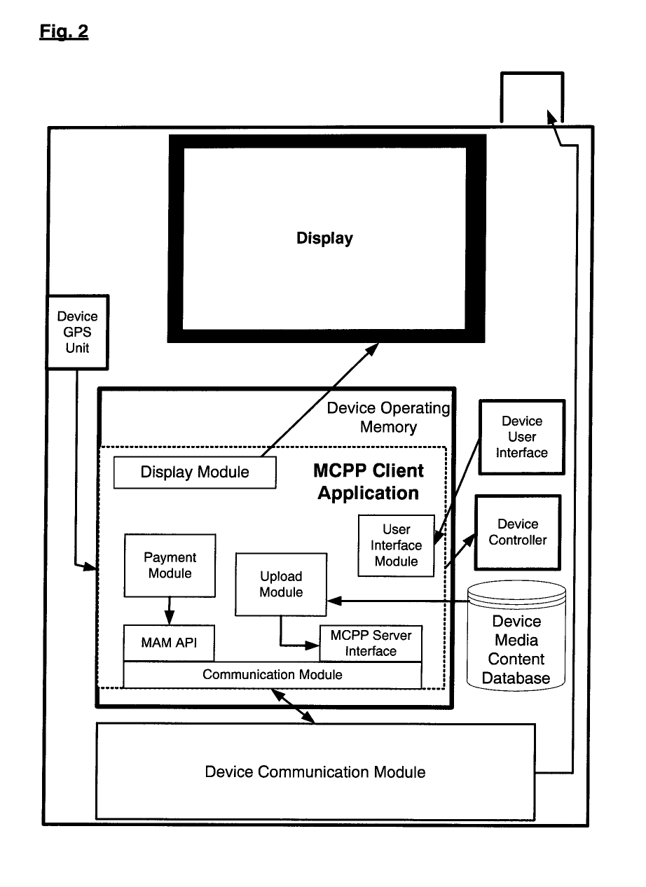

According to some embodiments, a MCPP client application may be provided. An MCPP client application may be designed to reside on a cellular phone (e.g. Iphone™, smartphone, etc.), another type of portable/mobile computing device (e.g. tablet) and/or any other computational platform. FIG. 2 is a block diagram of an exemplary computational device including a MCPP client application, in accordance with some embodiments of the present invention. As can be seen, the exemplary MCPP client application resides on the operating memory of the computational device and utilizes the native hardware of the computational device to perform its functions.

A MCPP client application may include viewer functionalities and/or author functionalities. Further, a MCPP client application may include a graphic user interface (GUI) including control elements for a user to select viewer functionalities and/or author functionalities. Understandably, a selection of viewer mode/functionalities or author mode/functionalities may result in a change of the GUI to accommodate the use in question.

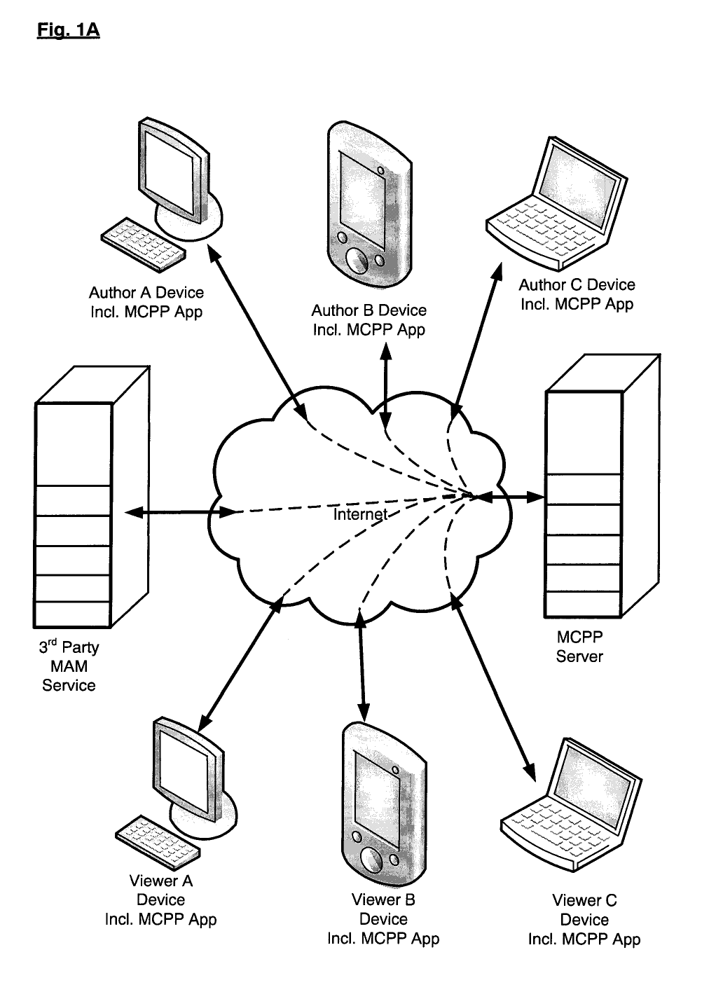

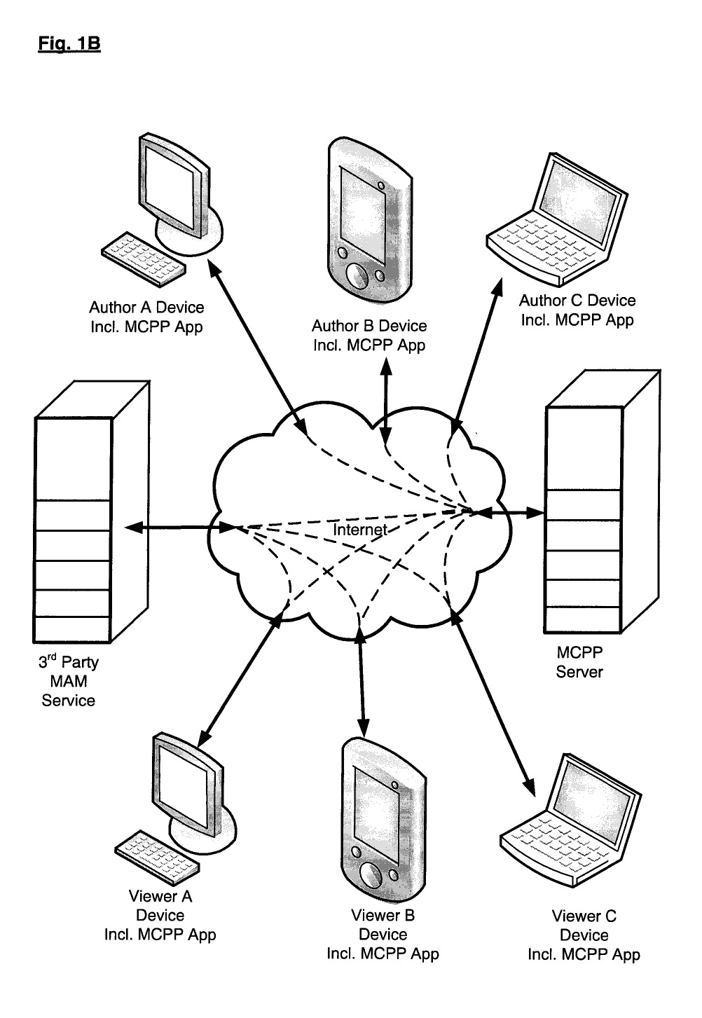

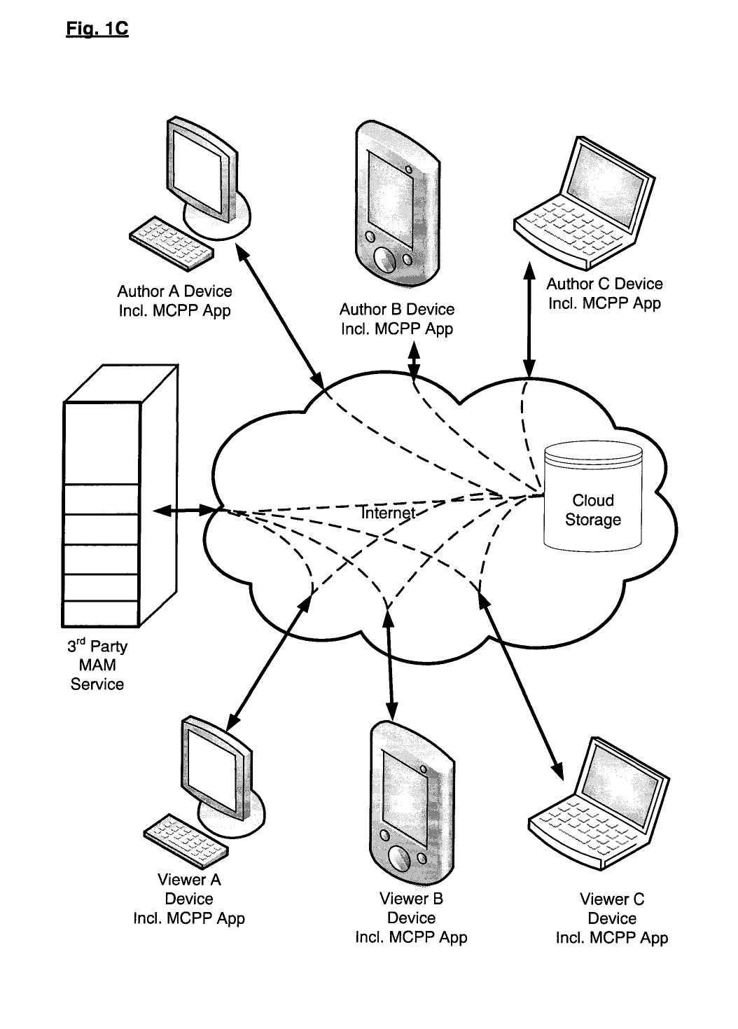

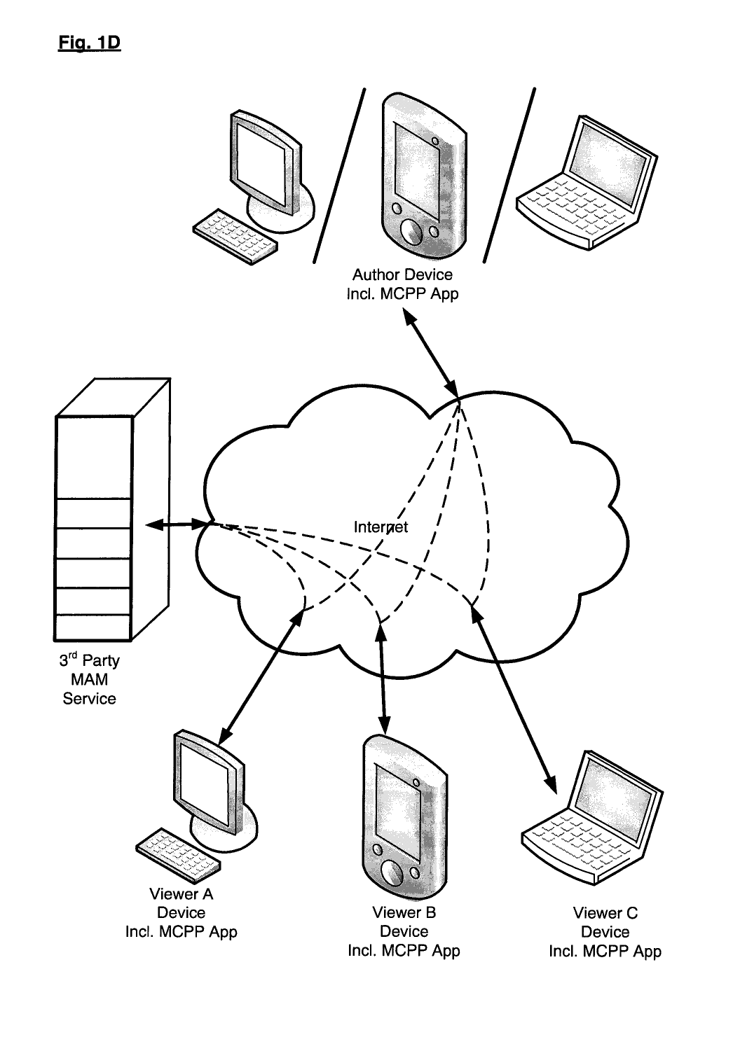

FIGS. 1A-1D illustrate exemplary architectures of MCPP systems, in accordance with some embodiments of the present invention, wherein FIG. 1A demonstrates an exemplary MCPP system in which Author Users A, B and C upload media contents to a MCPP server, Viewer Users view media content from the MCPP server and the MCPP server charges the Viewer Users for the Content through a MAM service; FIG. 1B demonstrates an exemplary MCPP system in which Author Users A, B and C upload media contents to a MCPP server, Viewer Users view media content from the MCPP server and the Viewer Users' MCPP client applications charge the Viewer Users for the content through a MAM service; FIG. 1C demonstrates an exemplary MCPP system in which Author Users A, B and C upload media contents to a Cloud storage, Viewer Users view media content from the Cloud storage and the Viewer Users' MCPP client applications charge the Viewer Users for the content through a MAM service, all in accordance with some embodiments of the present invention; and FIG. 1D demonstrates an exemplary MCPP system in which Author Users A, B and C send the media content directly to Viewer Users devices and the Viewer Users' MCPP client applications charge the Viewer Users for the content through a MAM service, all in accordance with some embodiments of the present invention;

### Author Functionalities

The present description refers to all suppliers/dealers of media content as authors. Accordingly, the term “author” herein should be understood to include any party supplying media content, such as but not limited to authors of media content, creators of media content, producers of media content, distributors of media content, performers of media content, photographers/filmers of media content and so on.

According to some embodiments, a MCPP client application may provide for an author user to upload media content or a link to media content to an associated content server. According to further embodiments, a MCPP client application may further provide for an author user to set a price for the uploaded or linked content. Alternatively, the price of a given content may be set by the MCPP system or in conjunction/negotiation/agreement with the MCPP system. Accordingly, a MCPP system/application may include price setting logic and associated policies and/or pre-programmed criteria/parameters for setting prices for content.

According to some embodiments, a MCPP client application may provide for an author to upload previews, descriptions and/or any other indications of the nature of the content or marketing materials relating to the content he/she is presenting on the system, or links to such previews, descriptions and/or any other indications of the nature of the content. Such previews, descriptions and/or any other indications of the nature of the content or marketing materials relating to the content may be presented to potential viewers/purchasers of the content. According to further embodiments, such previews/descriptions may also or alternatively be created by the MCPP system. According to yet further embodiments, such previews/descriptions may be created automatically by the MCPP system and/or automatically retrieved from exterior databases (e.g. by an internet search). For example, an initial segment or collection of partial segments of the media may automatically be extracted from the media content to create a preview of the content.

According to some embodiments, criteria for price setting for media content may include one or more of: (1) author selected/requested price, (2) content type, size and/or quality (e.g. video or audio, HD or normal, live or previously recorded, short clip or full movie, etc.), (3) the author of the given content (e.g. amateur or pro, based on success of the specific author's previous content, private individual or company, etc.), (4) a rating or other type of assessment of the author of the given content or the content itself, (5) a viewer response, possibly dynamically after the content/link has been uploaded and presented (e.g. the price of viewing a given concert live may rise or fall as the concert approaches, the price of content featuring media currently in high demand may be higher, etc), (6) geographical location of the content or viewer, (7) a time of day or day of week/month/year, (8) a type of compensation plan associated with the content, (9) a specific arrangement associated with the given author or group of authors to which the given author belongs (10) market considerations, (11) any other relevant criteria, or (12) a combination of the above.

According to further embodiments, a MCPP client application may also provide for an author user to designate the content as free with a tipping/donating option. Clearly, a tipping/donating option may be provided with paid content as well.

According to some embodiments, a MCPP client application may also provide for an author user to upload an invitation to view future content (e.g. a broadcast of a performance/show/event due to occur in the future) and set a price for the future content. The MCPP client application may further provide for an author, in such a case, to set separate prices for live viewing of the content and playback viewing. According to yet further embodiments, a MCPP client application may provide for an author user to upload content periodically and set a price for a subscription to his/her content. According to further embodiments, automatic price setting by the MCPP system as discussed herein and/or negotiated price setting between the author and the system as discussed herein may be implemented in relation to future content as well.

According to further embodiments, a MCPP client application may further provide for an author to set time limits on the content, such that the content or link may be removed from the server after the specified time period.

A MCPP client application may further include different methods for an author to receive compensation for his/her content. For example, the author may receive payment by means of check, credit to a credit card account, direct deposit, paypal credit, credit on the MCPP system to view other authors content, and/or any other payment method known today or to be devised in the future. The MCPP may yet further include control elements in the GUI to allow a user to select a payment method and provide the relevant details.

According to some embodiments, a MCPP system may include one or more compensation plans for authors, which may include:
a. Fixed price—an author may receive a fixed price for a given content regardless of the number of views;
b. Percentage based—an author may receive a percentage of revenues from the given content;
c. Price per view—an author may receive a fixed sum per view/subscription of the content;
d. Staggered compensation—an author compensation may be staggered, such that the first x views are compensated in one way or based on a certain percentage/price, the next y views compensated in another way or based on a different percentage/price, and so on;
e. Ladder type compensation—an author may receive pre-defined sums for reaching defined thresholds of views/likes, e.g. x if at least 100 views, y if 100-1000 views, z if 1000-10000 views and so on;
f. Any other type of compensation plan known today or to be devised in the future; or
g. Any combination of the above.

According to some embodiments, authors posting free content with a donation/tipping option may receive different compensation from authors posting paid content.

According to some embodiments, a MCPP client application may: (1) provide for an author to select a compensation plan from one or more of the above mentioned options, (2) designate one or more compensation plans for a given content upload based on the content type, size and/or quality (e.g. video or audio, HD or normal, live or previously recorded, short clip or full movie, etc.), (3) designate one or more compensation plans for a given content based on the author of the given content (e.g. amateur or pro, based on success of the specific author's previous content, etc.), (4) designate one or more compensation plans for a given content based on a rating or other type of assessment of the author of the given content or of the content itself, (5) designate one or more compensation plans for a given content based on any other relevant criteria, or (6) a combination of the above.

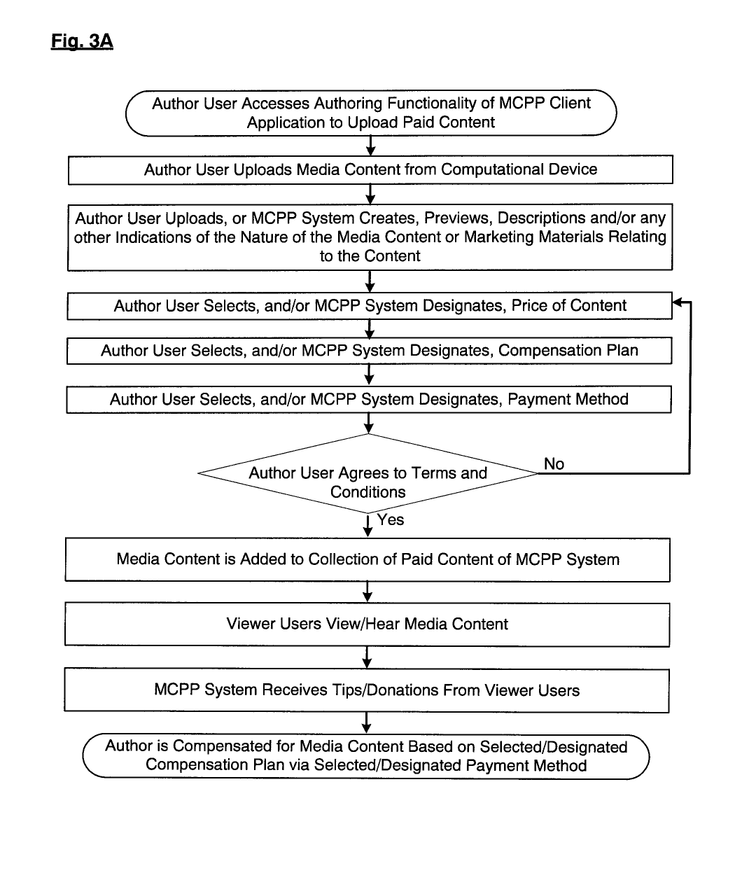

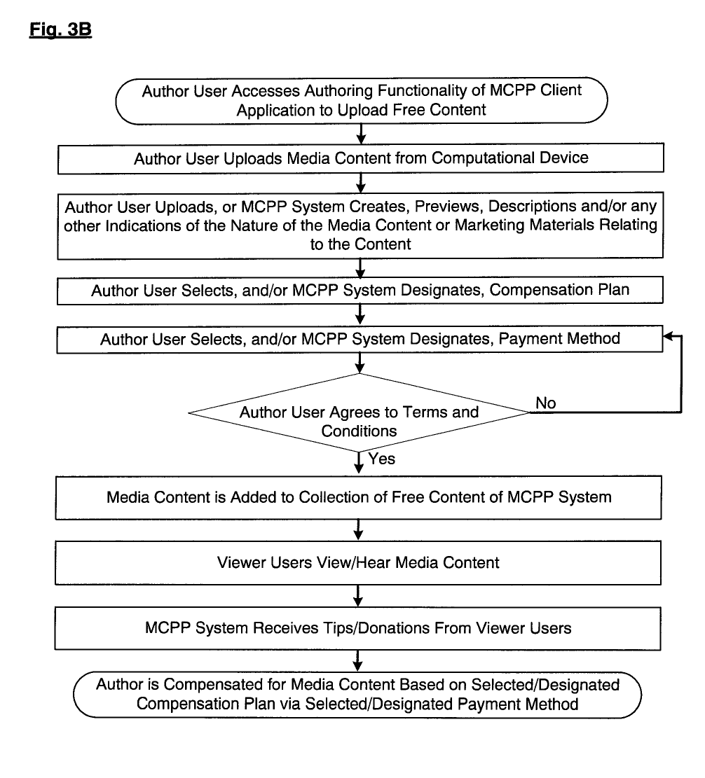

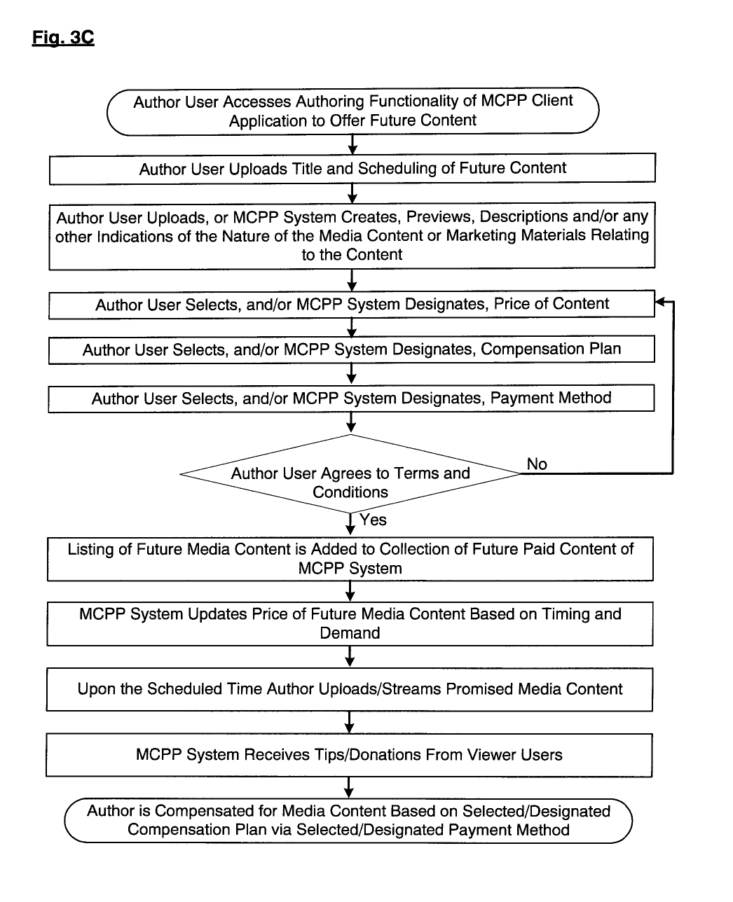

FIGS. 3A-3C: are flowcharts presenting exemplary steps of operation of an exemplary MCPP system performing Author functionalities:

FIG. 3A demonstrates exemplary uploading of paid content to an exemplary MCPP system. As can be seen in FIG. 3A, according to some embodiments, exemplary steps of operation of an exemplary MCPP system performing Author functionalities of uploading of paid content to an exemplary MCPP system may comprise: (1) an author user accesses an authoring functionality of a MCPP client application to upload paid content; (2) the author user uploads media content from a computational device; (3) the author user uploads, or the MCPP system creates, previews, descriptions and/or any other indications of the nature of the media content or marketing materials relating to the content); (4) the author user selects, and/or the MCPP system designates, a price of the content; (5) the author user selects, and/or the MCPP system designates, a compensation plan for the content (6) the author user selects, and/or the MCPP system designates, payment method; (7) the author user agrees to terms and conditions? if no—method returns to step (4), if yes then (8) the media content is added to a collection of paid content of the MCPP system; (9) the viewer users view/hear media content; (10) the MCPP system receives tips/donations from viewer users; and (11) the author is compensated for the media content based on the selected/designated compensation plan via the selected/designated payment method.

FIG. 3B demonstrates exemplary uploading of free content to an exemplary MCPP system. As can be seen in FIG. 3B, according to some embodiments, exemplary steps of operation of an exemplary MCPP system performing Author functionalities of exemplary uploading of free content to an exemplary MCPP system may comprise: (1) an author user accesses an authoring functionality of a MCPP client application to upload free content; (2) the author user uploads media content from a computational device; (3) the author user uploads, or the MCPP system creates, previews, descriptions and/or any other indications of the nature of the media content or marketing materials relating to the content; (4) the author user selects, and/or the MCPP system designates, a compensation plan for the content (5) the author user selects, and/or the MCPP system designates, payment method; (6) the author user agrees to terms and conditions? if no—method returns to step (4), if yes then (7) the media content is added to a collection of free content of the MCPP system; (8) the viewer users view/hear media content; (9) the MCPP system receives tips/donations from viewer users; and (10) the author is compensated for the media content based on the selected/designated compensation plan via the selected/designated payment method.

FIG. 3C demonstrates exemplary uploading of future content to an exemplary MCPP system. As can be seen in FIG. 3C, according to some embodiments, exemplary steps of operation of an exemplary MCPP system performing Author functionalities of uploading of future content to an exemplary MCPP system may comprise: (1) an author user accesses an authoring functionality of a MCPP client application to upload future content; (2) the author user uploads title and scheduling of future content from a computational device; (3) the author user uploads, or the MCPP system creates, previews, descriptions and/or any other indications of the nature of the media content or marketing materials relating to the content; (4) the author user selects, and/or the MCPP system designates, a price of the content; (5) the author user selects, and/or the MCPP system designates, a compensation plan for the content (6) the author user selects, and/or the MCPP system designates a payment method; (7) the author user agrees to terms and conditions? if no—method returns to step (4), if yes then (8) a Listing of the Future Media Content is Added to a Collection of Future Paid Content of the MCPP System; (9) the MCPP System Updates the Price of the Future Media Content Based on Timing and Demand; (10) Upon the Scheduled Time the Author Uploads/Streams the Promised Media Content; (11) the viewer users view/hear media content; (12) the MCPP system receives tips/donations from viewer users; and (13) the author is compensated for the media content based on the selected/designated compensation plan via the selected/designated payment method.

### Viewer Functionalities

According to some embodiments, a viewer GUI of a MCPP client application may provide a viewer user with a list/display of available contents for selection. The list/display may be arranged in any known manner of displaying lists of media content and may further include search and filtering functionalities as well known in the art. Similarly, the GUI may include other well known in the art functionalities relating to such lists/displays, such as but not limited to, identifying and displaying contents similar to currently/previously viewed contents, displaying contents based on user preferences, displaying contents by groups, displaying recommended contents or commonly viewed contents, displaying contents the MCPP system proprietor wishes to promote, displaying one or more of the above groups more prominently or alongside searched contents, etc.

According to some embodiments, each content in the list/display may be indicated by an image or other identifying indication of the content and may further include an image, logo, name or other indication of the author of the content. Each content may further be associated with a preview, description and/or any other indications of the nature of the content or marketing materials relating to the content. The preview, description and/or any other indications of the nature of the content or marketing materials relating to the content may be presented alongside the content indicator, upon “mousing over” or otherwise displaying interest in the content indicator and/or by viewer user request. According to some further embodiments, a MCPP client application may allow a viewer user to view a portion(s) or preview of a given content for free prior to purchasing the content. For example, a MCPP client application may allow a viewer user to view the first ten minutes of a movie for free prior to deciding if he/she wishes to purchase viewing rights for the movie.

According to further embodiments, each content in the list/display may further be associated with a price for viewing the content. As explained above, each content may have a given price and/or groups/types of content may have the same price (e.g. movies for 9.99, movies for 14.99 and brand new movies for 19.99). The price of a content may be displayed alongside the indicator of the content, may be displayed in relation to a group of contents and/or may not be displayed in the main listing and only displayed upon request by a user viewer or when further details of the content are displayed. Further, a MCPP system may implement many known selling techniques, including but limited to sales on certain types of content, discounted prices for multiple purchases or specific groups of users, sales during certain times of day, purchase of larger amounts of credit at a discounted price and/or any other type of relevant marketing scheme. Equally, subscriptions to specific authors, types of content, times of day, all included subscriptions may be sold on an MCPP system.

According to further embodiments, an MCPP system may also offer media content which can be viewed/heard for free. Listings/displays of free content may be in conjunction and/or separate from paid content listing/display. Free content may also be displayed with a graphic indication of its free nature. According to further embodiments, when a viewer user selects to view free content, the MCPP client application may provide along with or subsequent to the content a tip/donation control element designed to allow the viewer user to provide an optional payment/tip/donation in response to the free content. The control element may further allow a viewer user to determine/select the amount he/she wishes to tip/donate. Tips/donations/optional payment may be collected from the viewer users via a MAM, using an appropriate API, similarly to the collection of payment for paid content. Clearly, a tipping/donating option may be provided with paid content as well.

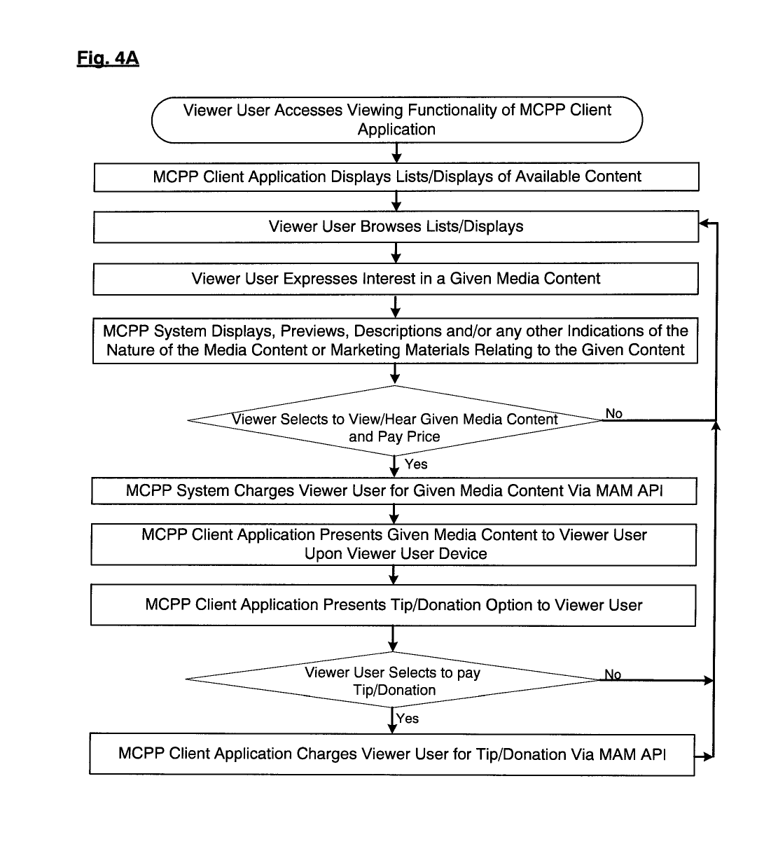

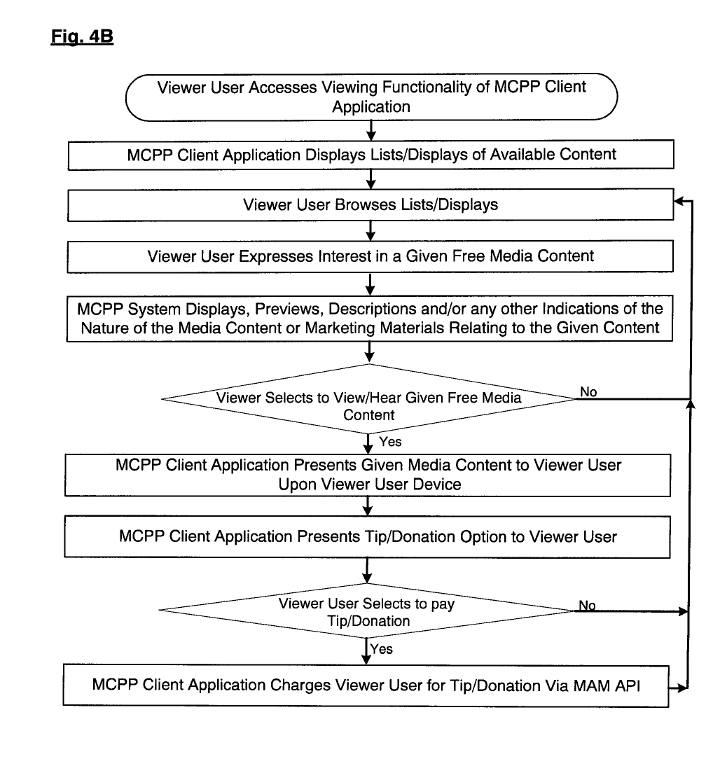

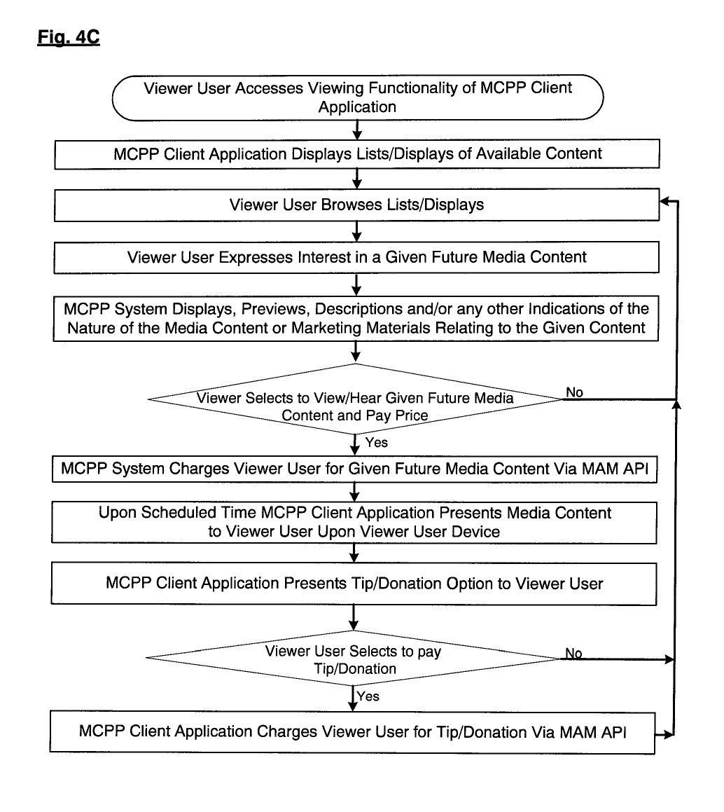

FIGS. 4A-4C: are flowcharts presenting exemplary steps of operation of an exemplary MCPP system performing Viewer functionalities:

FIG. 4A demonstrates exemplary selection and viewing of paid content facilitated by an exemplary MCPP system. As can be seen in FIG. 4A, according to some embodiments, exemplary steps of operation of an exemplary MCPP system performing Viewer functionalities of viewing of paid content facilitated by an exemplary MCPP system may comprise: (1) a Viewer User Accesses Viewing Functionality of a MCPP Client Application; (2) the MCPP client application displays lists/displays of available content; (3) the viewer user browses lists/displays; (4) the viewer user expresses interest in a given media content; (5) the MCPP system displays, previews, descriptions and/or any other indications of the nature of the media content or marketing materials relating to the given content; (6) the viewer selects to view/hear the given media content and pay the price? if no—the method returns to step (3), if yes: (7) the MCPP system charges the viewer user for the given media content via a MAM API; (8) the MCPP client application presents the given media content to the viewer user upon the viewer user device; (9) the MCPP client application presents a tip/donation option to the viewer user; (10) the viewer user selects to pay the tip/donation? If no, the method returns to step (3), if yes: (11) the MCPP client application charges the viewer user for the tip/donation via a MAM API and then the method returns to step (3).

FIG. 4B demonstrates exemplary selection and viewing of free content facilitated by an exemplary MCPP system. As can be seen in FIG. 4A, according to some embodiments, exemplary steps of operation of an exemplary MCPP system performing Viewer functionalities of selection and viewing of free content facilitated by an exemplary MCPP system may comprise: (1) a Viewer User Accesses Viewing Functionality of a MCPP Client Application; (2) the MCPP client application displays lists/displays of available content; (3) the viewer user browses lists/displays; (4) the viewer user expresses interest in a given free media content; (5) the MCPP system displays, previews, descriptions and/or any other indications of the nature of the media content or marketing materials relating to the given content; (6) the viewer selects to view/hear the given free media content? if no—the method returns to step (3), if yes: (7) the MCPP client application presents the given media content to the viewer user upon the viewer user device; (8) the MCPP client application presents a tip/donation option to the viewer user; (9) the viewer user selects to pay the tip/donation? If no, the method returns to step (3), if yes: (10) the MCPP client application charges the viewer user for the tip/donation via a MAM API and then the method returns to step (3).

FIG. 4C demonstrates exemplary selection and viewing of future content facilitated by an exemplary MCPP system. As can be seen in FIG. 4c, according to some embodiments, exemplary steps of operation of an exemplary MCPP system performing Viewer functionalities of selection and viewing of future content facilitated by an exemplary MCPP system may comprise: (1) a Viewer User Accesses Viewing Functionality of a MCPP Client Application; (2) the MCPP client application displays lists/displays of available content; (3) the viewer user browses lists/displays; (4) the viewer user expresses interest in a given future media content; (5) the MCPP system displays, previews, descriptions and/or any other indications of the nature of the media content or marketing materials relating to the given content; (6) the viewer selects to view/hear the given future media content and pay the price? if no—the method returns to step (3), if yes: (7) the MCPP system charges the viewer user for the given future media content via a MAM API; (8) upon the scheduled time the MCPP client application presents the given media content to the viewer user upon the viewer user device; (9) the MCPP client application presents a tip/donation option to the viewer user; (10) the viewer user selects to pay the tip/donation? If no, the method returns to step (3), if yes: (11) the MCPP client application charges the viewer user for the tip/donation via a MAM API and then the method returns to step (3).

According to some embodiments, a MCPP client application may provide along with or subsequent to paid content a tip/donation control element designed to allow the viewer user to provide an optional payment/tip/donation in response to the paid content.

According to some embodiments, as explained above, payments and/or donations/tips for content executed on a MCPP system may be facilitated via third party MAM's. For this purpose, a MCPP client application or associated server may include one or more appropriate API's for communicating with MAM's and collecting payment via their services. Obviously, the proprietors of the MAM's will charge a fee for their services, which fee should be considered in the financial planning and associated pricing and compensation agreements of a MCPP system.

According to some embodiments, the above described transactions relating to content may relate uniquely to viewing rights, i.e. may not include rights to otherwise use and/or download the content. According to further embodiments, a MCPP system may implement safeguards to prevent and/or identify downloading and/or misuse of content. According to yet further embodiments, a MCPP system may include options for users to purchase and sell content for other purposes as well (e.g. for downloading content and/or using content for commercial or academic purposes). Clearly, pricing for downloading or otherwise using content may be different from the prices for viewing the content. Further, in such embodiments, a MCPP client application may include control elements for authors to select and price the rights in their content they wish to sell and may further include separate displays for viewer users who wish to purchase rights, other than viewing rights in content. Further, content indicators may include indications what rights are available for purchase in relation to each content. According to further embodiments, auctioning of Author rights in relation to content may be performed by a MCPP system and/or bidding on providing authoring services to a buyer of author rights.

According to some embodiments, media content may be uploaded by authors to an associated MCPP server having storage ability to store the content and later provide the content to viewer users. According to further embodiments, the content may be stored by a MCPP client application in cloud storage and later accessed directly by viewers MCPP client applications. According to yet further embodiments, the content may be stored locally at the Author's device and later sent directly from the Author's MCPP client application to viewers MCPP applications.

According to some embodiments, a MCPP system may be designed to function both online and offline. Accordingly, a MCCP client application may be designed to allow an author user to perform all the steps of uploading a content or link to content while his/her computing device is offline, retain the link or content on a local storage and perform the actual upload the next time the computing device is online, possibly automatically. Similarly, a MCCP client application may be designed to allow a viewer user to view content previously purchased, offline.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for facilitating media content presentation and payment (MCPP), said system comprising:
a MCPP server;
a first processor functionally associated with a first digital memory, which first digital memory stores first processor executable code adapted to cause one or more processors of a first computational device to upload to said MCPP server a first media content stored on the first computational device and selected by a first user of the first computational device;
and
a second processor functionally associated with a second digital memory, which second digital memory stores second processor executable code adapted to cause one or more processors of a first mobile communication device to:
a) present to a second user of the first mobile communication device a list of available media contents including the first media content;
b) receive from the second user an agreement to purchase viewing rights in relation to the first media content; and
c) present to the second user the first media content; and
wherein said system is adapted to charge the second user for the viewing rights, by using a third party mobile application market service and compensate the first user for sale of the viewing rights to the second user.

2. The system according to claim 1, wherein said first processor executable code is further adapted to cause the one or more processors of the first computational device to automatically determine, in conjunction with said MCCP server, a price for the viewing rights.

3. The system according to claim 2, wherein said first processor executable code is further adapted to cause the one or more processors of the first computational device to automatically and dynamically determine, in conjunction with said MCCP server, a price for the viewing rights based on demand for the media content by other viewers.

4. The system according to claim 1, wherein:
said second processor executable code is further adapted to cause the one or more processors of the first mobile communication device to:
(a) present a user interface control element to the second user, which control element facilitates a donation or tip from the second user in relation to the first media content; and
(b) receive from the second user an agreement to provide a tip or donation in relation to the first media content;
and
said system is further adapted to charge the second user for the tip or donation, by using a third party mobile application market service and compensate the first user at least a portion of the tip or donation.

5. The system according to claim 1, wherein:
said second processor executable code is further adapted to cause the one or more processors of the first mobile communication device to receive from the second user an agreement to purchase rights to download the first media content; and
said system is further adapted to charge the second user for the rights to download the first media content, by using a third party mobile application market service and compensate the first user for sale of the rights to download the first media content to the second user.

6. The system according to claim 1, wherein:
said second processor executable code is further adapted to cause the one or more processors of the first mobile communication device to receive from the second user an agreement to purchase rights to commercially use the first media content; and said system is further adapted to charge the second user for the rights to commercially use the first media content, by using a third party mobile application market service and compensate the first user for sale of the rights to commercially use the first media content to the second user.

7. A system for facilitating media content presentation and payment (MCPP), said system comprising:
a MCPP server;
a first processor functionally associated with a first digital memory, which first digital memory stores first processor executable code adapted to cause one or more processors of a first computational device to upload to said MCPP server a first media content stored on the first computational device and selected by a first user of the first computational device;
and
a second processor functionally associated with a second digital memory, which second digital memory stores second processor executable code adapted to cause one or more processors of a first mobile communication device to:
a) present to a second user of the first mobile communication device a list of available media contents including the first media content;
b) present a user interface control element to the second user, which control element facilitates a donation or tip from the second user in relation to the first media content;
c) receive from the second user an agreement to provide a tip or donation in relation to the first media content; and
d) present to the second user the first media content; and
wherein said system is adapted to charge the second user for the tip or donation, by using a third party mobile application market service and compensate the first user at least a portion of the tip or donation.

8. The system according to claim 7, wherein:
said second processor executable code is further adapted to cause the one or more processors of the first mobile communication device to receive from the second user an agreement to purchase rights to download the first media content; and
said system is further adapted to charge the second user for the rights to download the first media content, by using a third party mobile application market service and compensate the first user for sale of the rights to download the first media content to the second user.

9. The system according to claim 7, wherein:
said second processor executable code is further adapted to cause the one or more processors of the first mobile communication device to receive from the second user an agreement to purchase rights to commercially use the first media content; and said system is further adapted to charge the second user for the rights to commercially use the first media content, by using a third party mobile application market service and compensate the first user for sale of the rights to commercially use the first media content to the second user.

10. A method for facilitating media content presentation and payment (MCPP), said method comprising:
receiving from a first computational device, at a MCPP server, a first media content stored on the first computational device and selected by a first user of the first computational device;
receiving an agreement by a second user to pay a sum in relation to the first media content;
charging the second user the sum, using a third party mobile application market service.

11. The method according to claim 10, further comprising compensating the first user for the media content a portion of the sum.

12. The method according to claim 10, wherein said receiving an agreement by a second user to pay a sum in relation to the first media content is performed after providing the second user with the first media content.

13. The method according to claim 10, further comprising automatically determining the sum, by the MCCP server.

14. The method according to claim 10, further comprising automatically and dynamically determining the sum, by the MCCP server, based on demand for the media content by other viewers.

15. The method according to claim 10, further comprising:
a. presenting a user interface control element to the second user, which control element facilitates a donation or tip from the second user in relation to the first media content; and
b. receiving from the second user an agreement to provide a tip or donation in relation to the first media content;
c. charging the second user for the tip or donation, using a third party mobile application market; and
d. compensating the first user at least a portion of the tip or donation.

16. The method according to claim 10, wherein the sum is in exchange for rights to download the first media content.

17. The method according to claim 10, wherein the sum is in exchange for rights to commercially use the first media content.

18. The method according to claim 10, wherein said receiving from a first computational device a first media content is performed after said receiving an agreement by a second user to pay a sum in relation to the first media content and after charging the second user the sum.

19. The method according to claim 18, further comprising receiving an invitation to view a future media content from the first user, prior to said receiving an agreement by a second user to pay a sum in relation to the first media content; and wherein the first media content is the future media content.

20. The method according to claim 18, further comprising automatically and dynamically determining the sum, by the MCCP server, based on a time left before an expected time of presentation of the first media content.
